(19) United States
(12) Patent Application Publication
(10) Pub. No.: US 2014/0082111 A1
(43) Pub. Date: Mar. 20, 2014

(54) DOCUMENT DELIVERY SYSTEM WITH EMAIL UPLOADER FOR AUTOMATIC STORAGE OF DOCUMENTS IN A USER ACCOUNT

(71) Applicant: DWCD Direct LLC, Carmarillo, CA (US)

(72) Inventors: Stephen Schneider, Covina, CA (US); Christopher Floyd, Camarillo, CA (US); David DePaolo, Camarillo, CA (US)

(21) Appl. No.: 14/085,625

(22) Filed: Nov. 20, 2013

Related U.S. Application Data
(63) Continuation-in-part of application No. 13/561,609, filed on Jul. 30, 2012, now Pat. No. 8,600,904.

(51) Int. Cl. H04L 12/58

(52) U.S. Cl. CPC H04L 51/08
USPC 709/206

(57) ABSTRACT

A computer program product and method for delivery of electronic and physical documents, with an email interface for uploading documents to be automatically stored in a user's account. The system may receive uploaded electronic documents for delivery to one or more electronic and/or physical endpoints. After the electronic documents have been received, the delivery system determines whether the received electronic documents should be delivered electronically or physically, based on recipient data in the delivery system. If physical documents are to be delivered, the system may intelligently decide whether to aggregate some documents into a multi-document package. The system provides for delivery by commercial carrier, postal service, and/or electronic delivery. Optional services available to the sender include, but are not limited to, certified mail, proof of service, and email confirmation.

### CROSS-REFERENCE TO RELATED APPLICATIONS

The present application is a continuation-in-part of nonprovisional application Ser. No. 13/561,609, filed on or about Jul. 30, 3012 entitled “Document Delivery System with Proof of Service,” naming the same inventors as in the present application. This application is incorporated herein by reference the same as if fully set forth.

### BACKGROUND OF THE INVENTION

1. Field of Invention

The present disclosure relates to document delivery systems and, more particularly, to a delivery system for electronic or paper documents with proof of service of same.

2. Description of Related Art

Delivery of physical documents has been an important part of daily life for quite some time. At one point, the United States Postal Service and commercial carriers, e.g., Federal Express™, and/or personal couriers, were the main avenues for the delivery of physical documents. With the rise of computers, electronic documents are being delivered with increasing frequency.

Under certain circumstances, it may be crucial or significant for the sender to verify that the documents have been sent to the intended recipient. In fact, in some cases, e.g., where legal and financial documents are involved, it may be required that the sender establish service to a recipient of the contents of transmitted documents. Businesses may exchange millions of electronic documents for which proof of service may be useful or required.

Accordingly, there is a need for a hybrid document delivery system that provides for proof of service of both physical and electronic documents.

In the field of document delivery, it may be inefficient to deliver different physical packages to the same physical delivery address. Accordingly, there is a need for aggregating documents addressed to the same delivery address into a single physical package.

### BRIEF SUMMARY OF DISCLOSURE

The present disclosure addresses the needs noted above by providing a delivery system for electronic and paper documents with email uploader. In accordance with one embodiment of the present disclosure, a non-transitory computer-readable medium is provided for uploading documents via email and delivering the uploaded documents to electronic and/or physical endpoints. The computer readable medium embodies a set of instructions which, when executed by one or more computer processors, comprise a document receipt code segment configured to receive electronic documents for delivery to one or more physical and/or electronic endpoints, including each electronic document associated with an email that is addressed to an assigned system email address. Recipient data is also received by the document receipt code segment, indicating delivery to one or more physical and/or electronic endpoints.

The instructions further include an extraction and storage code segment configured to extract each received electronic document from each said email that is addressed to an assigned system email address, the code segment being further configured to store the extracted received electronic document. The extraction and storage code segment is also configured to link the extracted received electronic document to a user account associated with the assigned system email address to which the email containing the received electronic document was addressed if the system email address to which the received electronic document is addressed matches an assigned system email address.

If a user account permits automatic email attachment inclusion or if an attachment command is received for a received electronic document, the instructions also comprise an automatic email attachment inclusion code segment configured to verify that a sending user is building a package for mailing to the one or more physical and/or electronic endpoints. The automatic email attachment inclusion code segment is further configured to automatically store each extracted received electronic document into the user account associated with the assigned system email address to which the received electronic document was addressed.

The instructions also include a mail delivery code segment configured to determine whether a received electronic document is to be delivered to a recipient via physical or electronic endpoint based on the recipient data. The mail delivery code segment is further configured to deliver the received electronic document to an electronic endpoint, if the determined endpoint is electronic.

The instructions also include an encryption code segment configured to provide encryption for each electronic document that is attached to each email addressed to an assigned system email address; and a decryption code segment configured to decrypt each extracted received electronic document that has been encrypted.

In accordance with another embodiment of the present disclosure, another non-transitory computer-readable medium is provided for uploading documents via email and delivering the uploaded documents to electronic and/or physical endpoints. When executed by one or more computer processors, the instructions comprise a document receipt code segment configured to receive electronic documents for delivery to one or more physical and/or electronic endpoints, including each electronic document associated with an email that is addressed to an assigned system email address. Recipient data may also be received, indicating delivery to one or more physical and/or electronic endpoints.

The instructions further comprise an extraction and storage code segment configured to extract each received electronic document from each said email that is addressed to an assigned system email address. The code segment is further configured to store the extracted received electronic document. The extraction and storage code segment is also configured to link the extracted received electronic document to a user account associated with the assigned system email address to which the email containing the received electronic document was addressed if the system email address to which the received electronic document is addressed matches an assigned system email address.

If a user account permits automatic email attachment inclusion, or if an attachment command is received for a received electronic document, an automatic email attachment inclusion code segment is provided. It is configured to verify that a sending user is building a package for mailing to the one or more physical and/or electronic endpoints. The automatic email attachment inclusion code segment is also configured to automatically store each extracted received electronic document into the user account associated with the assigned system email address to which the received electronic document was addressed. The instructions also comprise a mail delivery code segment configured to determine whether a received electronic document is to be delivered to a recipient via physical or electronic endpoint based on recipient data, wherein the mail delivery code segment is further configured to deliver the received electronic document to an electronic endpoint, if the determined endpoint is electronic.

The instructions comprise a formatting code segment configured to format each received physical endpoint according to a formatting standard that permits aggregation of received electronic documents from multiple senders to a physical endpoint composed of known address components that substantially match address components for more than one received physical endpoint. Also included in the instructions is an aggregation code segment configured to facilitate the aggregation of physical documents into a single multi-document package from the multiple senders for delivery to the one or more endpoints, if the determined endpoint is physical.

In yet another embodiment of the present disclosure, a computer-based method is provided for receiving electronic documents via email, and delivering the received electronic documents to physical and/or electronic endpoints. The method comprises providing, by a computer, encryption for each electronic document that is attached to each email addressed to an assigned system email address. The method also comprises receiving, by the computer, a plurality of electronic documents, including electronic documents that are emailed to one or more assigned system email addresses. The method further comprises receiving, by the computer, recipient data indicating delivery to one or more physical and/or electronic endpoints; extracting and storing, by the computer, each of the received electronic documents from the email addressed to the assigned system email address; and decrypting, by the computer, each extracted received electronic document that has been encrypted.

The method also comprises linking, by the computer, the extracted received electronic documents to at least one user account associated with the one or more assigned system email addresses to which the email containing the received electronic document was addressed. If a user account permits automatic email attachment inclusion or if an attachment command is received for the extracted received electronic document, performing the following steps for each of the plurality of extracted received electronic documents: verifying that a sending user is building a package for mailing to the one or more physical and/or electronic endpoints; and automatically storing each extracted received electronic document into the user account associated with the assigned system email address to which the received electronic document was addressed. The method also comprises determining, by the computer, whether a received electronic document is to be delivered to a recipient via physical or electronic endpoint based on recipient data. In response to the determining step, performing the following step for each of the plurality of received electronic documents: if the determining step indicates delivery to an electronic endpoint, delivering, by the computer, the received electronic documents to electronic endpoints.

These, as well as other objects, features and benefits will now become clear from a review of the following detailed description of illustrative embodiments and the accompanying drawings.

### BRIEF DESCRIPTION OF DRAWINGS

FIG. 1 is a flow chart for the document delivery system with proof of service in accordance with one embodiment of the present disclosure.

FIG. 2 is an electronic mail interface that a user may use to upload the documents into the document delivery system in accordance with one embodiment of the present disclosure.

FIG. 3 is a screenshot of a user's device as the user creates an email for uploading documents into the document delivery system of the present disclosure.

FIG. 4 is a screenshot that illustrates a user's account settings in accordance with one embodiment of the present disclosure.

FIG. 5 is a user screenshot that results after a user has successfully and automatically inserted an email attachment into a list of files in a mailing package in accordance with one embodiment of the disclosure.

FIG. 6 is a screenshot illustration of the initial screen shown when a sender submits a document into the document delivery system in accordance with one embodiment of the present disclosure.

FIG. 7 is a screenshot illustration showing an upload of a document into the document delivery system in accordance with one embodiment of the present disclosure.

FIG. 8 is a screenshot that permits a user to enter additional documents into a package for the document delivery system in accordance with one embodiment of the present disclosure.

FIG. 9 is a screenshot that permits a user to enter information for the package to be delivered in accordance with one embodiment of the present disclosure.

FIG. 10 is a screenshot that permits a user to enter a recipient for the package and submit the package for delivery in accordance with one embodiment of the present disclosure.

FIG. 11 is a screenshot that permits a user to select optional services for a package to be delivered by the document delivery system in accordance with one embodiment of the present disclosure.

FIG. 12 is a screenshot at a recipient's computer after the recipient has opened the package subject to proof of service in accordance with one embodiment of the present disclosure.

FIG. 13 is a proof of service generated by the system in accordance with one embodiment of the disclosure.

FIG. 14 is a screenshot of a sender's receipt record for the package subject to proof of service in accordance with one embodiment of the present disclosure.

### DETAILED DESCRIPTION OF THE DISCLOSURE

The document delivery computer program product and method of the present disclosure permits the receipt of uploaded electronic documents, including receipt of such documents via an email attachment when the email is addressed to an assigned system email address. The received electronic documents may be delivered in either physical or electronic form to one or more recipients or endpoints. The endpoints may be physical or electronic. A physical endpoint may be a street address, post office box or other physical location. An electronic endpoint may be an inbox associated with the intended recipient, and the inbox may be provided by the document delivery system. The upload may be accomplished by a sender/shipper, who may request that the documents be delivered to specified recipients or an alias associated with an endpoint. The alias may be, for example, a company name.

The document delivery system of the present disclosure may provide proof of service of both physical and electronic documents. These documents may include writings, photographs, images, graphs and charts. The documents may also include sound recordings, and other data or data compilations, e.g., computer programs or any other information. It should be noted that certain documents may originate in physical form and may be scanned and received or uploaded as electronic documents by the document delivery system.

After the electronic documents have been received by the document delivery system, the system's mail delivery subsystem may determine whether the received electronic documents should be delivered electronically or physically, depending on the delivery method chosen by the intended recipient. As used herein, documents uploaded and received by the document delivery system—but not yet served or delivered as physical and/or electronic documents—are referred to as received electronic documents. Where the intended recipient has chosen digital delivery to an electronic endpoint, the document may be delivered electronically to the system. The document may be opened thereafter by the intended recipient when the intended recipient logs onto his/her account. Where no delivery method has been designated, physical delivery to a physical endpoint may be the default option.

A proof of service may be generated once the delivery method has been determined. The proof of service may document how the method of delivery is to be made. As used herein, the terms “served electronic document” and “served physical document” refer to received electronic documents that have been served, but not necessarily delivered yet. However, a received electronic document that is to be served to an electronic endpoint may be considered served and delivered when it is delivered to the recipient's inbox. A received electronic document that is to be served to a physical endpoint may be considered served when it is placed into a physical mail stream and/or transferred or released to a physical carrier for delivery.

The proof of service may be digitally or electronically signed by a person associated with the system who certifies the manner in which proof of service is carried out. This part of the proof of service process is the same regardless of whether the documents are delivered electronically or physically. If the documents are to be electronically delivered, a copy of each document may be electronically delivered to the intended recipient via an inbox associated with the system or other electronic means. The proof of service may be attached to the document, if the document is electronically delivered.

If the documents are to be physically delivered, a document constituting the proof of service may become a part of the physical document package to be delivered. In this case, the documents may be physically released or transferred to a commercial carrier e.g., the United States Postal Service or FEDEX™, so that it may ultimately be delivered to the intended recipient at a physical endpoint. In this case, the document delivery system may rely on the third party carrier to effect delivery of the physical document. The proof of service may be inserted into the document as the last page.

Where the received electronic documents are to be delivered as physical documents, the document delivery system of the present disclosure may aggregate the documents into a single package at an efficient price point. The document delivery system may intelligently decide whether to aggregate the document along with other documents into a multi-document package and provide for delivery either by commercial carrier or other physical delivery method. As used herein, the term “delivered physical document” refers to a physical document that has been physically delivered to the physical endpoint for an intended recipient. The term “delivered electronic document” refers to an electronic document that has been electronically delivered to an electronic endpoint.

Optional services available to the sender may include, but are not limited to, certified mail, proof of service, and email confirmation. As for the certified mail option, the sender would choose this option if the sender wanted a certified receipt confirming physical delivery, not just a confirmation of mailing. Senders who select this option may receive a scanned image of a declaration of actual physical delivery and signature by the end point recipient. In the case of physical delivery, this image could be in the form of a signed United States Postal Service certified mail card, or an image of a declaration of personal physical service on the endpoint recipient by a person (such as from a courier service). In the case of electronic delivery, this image could also take the form of a signed declaration of an employee associated with the document delivery system. This declaration may confirm that the piece was delivered electronically within the network and was actually opened by the endpoint recipient.

As for the email confirmation option, the sender would choose this option if the sender wanted an email confirmation of the mailing of a document—not a confirmation that it was received or read. The system would send the sender an email when the document was mailed or delivered electronically. This email would not be a signed or confirmed receipt that the endpoint recipient read the document.

After the package has been delivered, the sender may receive a receipt that includes an audit log. Where the documents have been delivered electronically via the document delivery system, the audit log may show when the document was received at the recipient's electronic endpoint or, for delivery to physical endpoints, when the document was released or transferred to a carrier.

After document delivery to electronic endpoints, the system may thereafter track electronic actions taken in connection with the document/package. For example, the system may track when the document was opened, and/or when the document was printed and/or forwarded. A bar code associated with the document may facilitate its tracking. The audit log may also show when the intended recipient logged on to the system since the system is a web-based application programming interface (API). If a document was opened, the system may track how long it was opened. The system knows if the intended recipient saw the title for the transmitted document in their inbox. As long as the document is in the data server for the document delivery system, it can be tracked. The system may also include encryption or other data protection measures in order to prevent unauthorized access.

In some circumstances, a document may be delivered electronically by the document delivery system, but may remain unopened for a long period of time. In this case, the sender/shipper may elect to have the system recall the unopened document from the electronic delivery endpoint and change the delivery method to paper. Then, the system would re-send the previously delivered document as a paper document. The document delivery system of the present disclosure may be useful for a number of persons and entities, and may also be useful for businesses that regularly send documents back and forth to each other. Each document designated for delivery may have a unique identification number. Using that unique identification number, the document may be tracked from the time it is received by the system until it is delivered to an endpoint or recipient.

This document delivery system may be implemented as a web-based system. The system may be accessible via the Internet by subscribers who provide the proper authentication credentials.

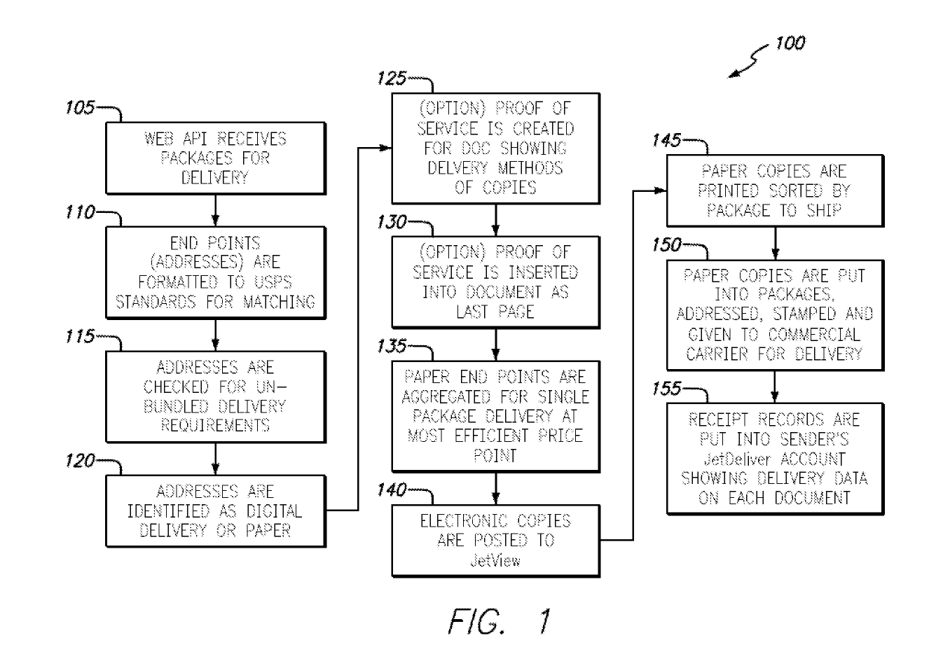

Referring now to FIG. 1, illustrated is a flow chart for the document delivery system in accordance with one embodiment of the present disclosure. Flow chart 100 includes steps that may be taken by the document delivery system from the time the packages are received up until the time the packages are delivered.

At step 105, the web application programming interface (API) may receive packages to be delivered by the document delivery system. The web API may permit the upload of documents via email, or any other suitable means for receipt. In the examples shown herein, the web interface may need to be in email mode in order to receive the upload of documents via email. In some configurations of the system described herein, the user may be required to upload at least one package via the browser or “my files” mode on the web API before the user is permitted to select the email upload option and receive uploads to his/her account via email. The system may remain in email mode until the user cancels or until user completes submission of his/her order. At step 110, the end points or recipients' addresses may be formatted according to certain standards. For example, the addresses may be formatted so that whenever the word “Boulevard” or “Boulv” or a variant thereof is typed, it appears as “Blvd.” or is corrected to appear as such. This way, there is consistency among the addresses and a match can be readily ascertained. Otherwise, the system may not understand that 103 Washington Boulevard and 103 Washington Blvd. are the same address. An example of a body of addressing standards are those implemented by the United States Postal Service, which can be found at Publication 28, Postal Addressing Standards 7610-03-000-3688, published in April 2010.

Along those same lines, if the user misspells a word in the address, the misspelling of the word can be recognized. For example, the system may be configured to correct “Bulevard”, an obvious misspelling that is substantially similar to the actual correct spelling, so that it reads “Blvd.” The document delivery system may also be able to determine where a street has been misaddressed as an avenue, a route has been misaddressed as a lane, etc.

At step 115, addresses may be checked for unbundled delivery requirements. Here, the package may be flagged where multiple persons/entities occupy the same address. If there are multiple occupants at the same address, then the system may determine that the packages cannot be aggregated as described in more detail in connection with step 135.

At step 120, the addresses may be identified as either a digital delivery address or a paper/physical delivery address. This identification may occur based on the manner in which people at the address have agreed to accept documents—via electronic or physical delivery. Subscribers to the document delivery system may elect to have all documents delivered electronically. For non-subscribers, the default may be set to physical delivery of all documents.

At step 125, optionally, a proof of service may be created for the document showing delivery methods of copies. If the proof of service option is chosen, then at step 130, the proof of service may be inserted as the last page of a document if a physical delivery method is chosen.

At step 135, paper end points may be aggregated. That is, multiple documents addressed to a single address may be aggregated into a single multi-document package. This way, delivery may be accomplished at the most efficient price point. In addition to price point, the scheduled delivery time may also be a determining factor in how the documents are aggregated. Based on the scheduled delivery time, common addresses may be pooled into one package. Collation of the mail to a single endpoint may occur prior to delivery of the documents to a print stream. Where the address is a shared suite with different entities sharing a common address, the system may decide to de-aggregate documents based on the address, and then to re-aggregate them based on name. In this case, documents addressed to a particular recipient may be contained in a single multi-document package. Hard copies of documents coming from the print stream may be delivered physically via common carrier or other suitable carrier.

The system may convert addresses into a standard format, e.g., a standard post office format. The system also may take into account the fact that different users may type in the same address in different ways. The system may convert an address into standard post office address format. For example, no matter how a user spells a street name, the system may recognize the misspelling and suggest a known post office standard address—even if the named recipient is different. The system may also look at the unique address, as standardized by the system, and determine whether the user has an account with an electronic mailbox to which all documents may be delivered. Again, as indicated above, if an address—e.g., a suite—is identified, the system may determine that aggregation or consolidation of the package should not occur with any other address.

The documents in the package may include a cover sheet and, for electronic delivery, the cover sheet may identify the particular person to whom the documents should be delivered. If the documents are delivered physically via common carrier, the documents may have identifying information that is customary for the third-party carrier. The documents and/or package may not necessarily include a cover sheet.

At step 140, electronic copies may be posted to the document delivery system so that they may be retrieved by the intended recipient, if the subscriber/recipient has agreed to accept electronic delivery. The document may be posted in any type of format suitable for the system, including but not limited to a portable document format (PDF), rich text format, word processing format e.g., MICROSOFT™ WORD™, or any other suitable format.

At step 145, paper copies may be printed and sorted by package for shipping. Sorting may occur before the physically-deliverable documents go to print. Sorting may occur manually so that the documents are stuck into package with paper identifiers. At step 150, paper copies may be placed into packages, stamped and given to a commercial carrier for delivery. At step 155, receipt records may be placed into the sender's account showing delivery data for each document. In the case of physical delivery, the shipper's receipt records may be created once the document has been released or transferred to the physical carrier. The document may be considered released or transferred to the physical carrier when, for example, it is placed into a mailbox for pickup by the United States Postal Service. The document may be considered released or transferred to the physical carrier when, for example, the documents are left in a deposit box under control of the carrier for pick-up by the carrier. In the case of electronic delivery, e.g., if the recipient has agreed to accept electronic delivery, the receipt records may be delivered into the electronic mailbox for the recipient's account.

Described herein are also various computer screenshots that may appear when a user uses the document delivery system to carry out physical and electronic delivery of single-document or multi-document packages. Documents may be uploaded to the system via an email from a user computing device, if the user account is in email mode. Alternatively, documents may be uploaded to the system through a system web interface.

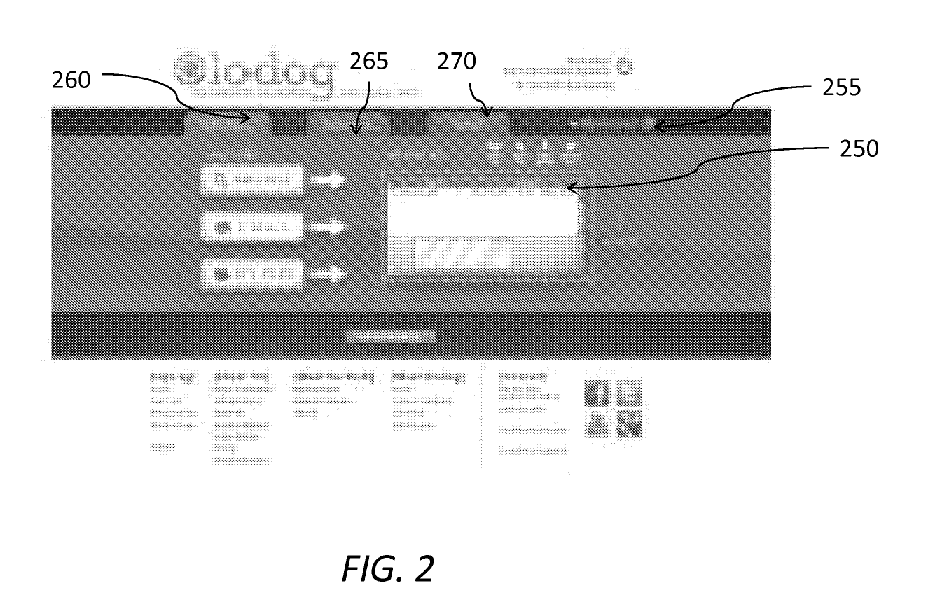

Referring now to FIG. 2, illustrated is a web-based email interface that a user may use to upload the documents into the document delivery system in accordance with one embodiment of the present disclosure. The user has selected the “my account” option as indicated by the “my account” display 255 at the top of the screen. As shown at line 250, the user has already inserted a file titled “invoice.pdf.” The file is three (3) pages, and was uploaded on Jan. 1, 2013 at 14:14. Also shown at line 250 are the file size and the file type. Here, the file size is 908K and the file type is PDF (portable document format). As shown at the top of the screen, three tabs are available for the user to select. The add files tab 260 has been selected by the user. The other options available to the user are the addresses tab 265 and send tab 270. Addressing and sending documents will be described later in this disclosure.

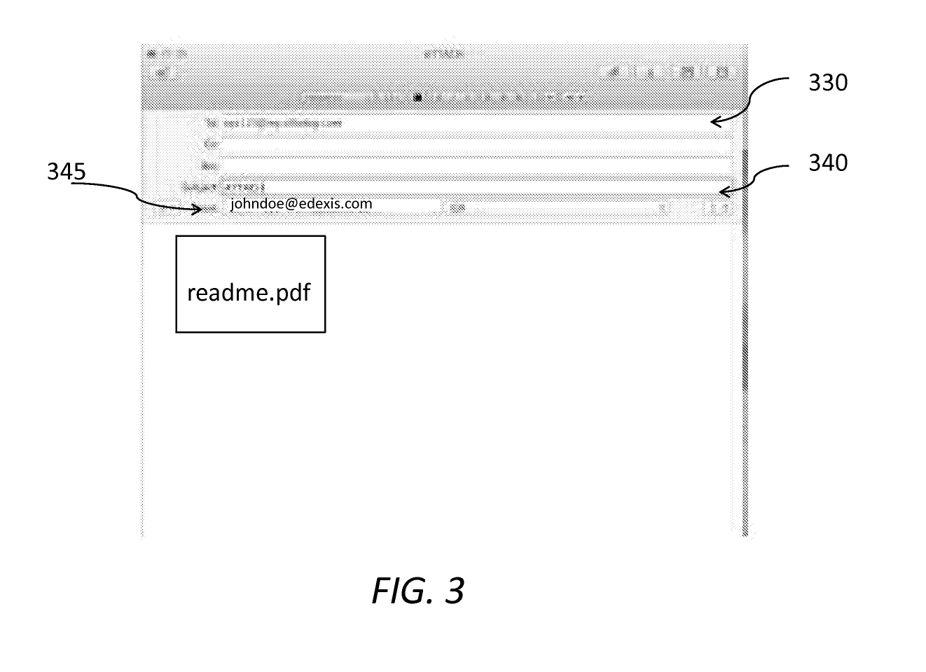

Referring now to FIG. 3, illustrated is a screenshot of a user's device as the user creates an email for uploading documents into the document delivery system of the present disclosure. The document delivery system is capable of receiving documents that the user uploaded via email and that the user has sent to the system via an assigned system email address for the user's account. The user may create the email from his/her computing device, and attach the documents the user desires to have delivered. The user's computing device may be, e.g., a desktop personal computer, a laptop, a tablet e.g., an IPAD™, or any other suitable computing device from which the user is able to send an email with attachments. In the present illustration in FIG. 3, the user is addressing the email to an email address that was assigned to the user by the system. Here, the email is from johndoe@edexis.com as shown at line 345. The user's assigned system email address is shown at line 330 as xyz123@olodog.com. For security purposes, the system may be configured to prohibit users from creating their own system email addresses. The system may be configured to only provide assigned system email addresses by random generation.

The system may also be able to recognize commands typed in the subject line of an email or otherwise. For example, here, the user has entered the word “attach” in the subject of the email at subject line 340. The user has attached one or more files to the email. However, the size of the user attachments may be subject to limitations of the user's email service provider. In this case, the user's service provider may not permit the email to be sent to the system if it exceeds the requisite size. In the present example, the user has attached a file entitled “readme.pdf” to the email. In order to send the email to the system server, the user may press send in the manner he/she would with any other email. If the system were not in mailing mode, the user may be permitted to send a command to enable mail mode. The user may also be able to use his/her system password to encrypt the email attachment in the email file.

The email sent by the user may be received by the document delivery system's server. The document delivery system's server may check the recipient address xyz123@olodog.com and confirm that this email account exists on the document delivery system's server. The server may also cross-reference the xyz123@olodog.com email address to the user account to which the email address belongs. If the system cannot match the email address with an assigned email address, the system may be configured to disregard and/or delete the received email and attachment if it cannot confirm that the email address to which the document was sent is not associated with a user account. The system may also be configured so that it does not communicate with the unconfirmed sender of the disregarded/deleted attachment because of security concerns.

In the present illustration, the server finds that the email address xyz123@olodoo.com belongs to John Doe. The server may extract the file attachment(s) from the email message and store the file in the document delivery system. Any email with an attachment that is addressed to an email address having the system domain can be extracted and stored to the system server. The system may then look at the root, e.g., xyz123 and associate the email address to which the email was addressed with a user account on the system. In this example, the server may link the email attachment with user John Doe's account with the document delivery system. On the system side, if a received electronic file has been encrypted, the server may automatically use the user's password to decrypt the file upon receipt. This decryption may occur after a sending user attaches files to a message (e.g., an email), and send the files to the user's assigned system email address. The server may decrypt the attached file(s) as soon as they are extracted from the email and before linking the attachment to a user account.

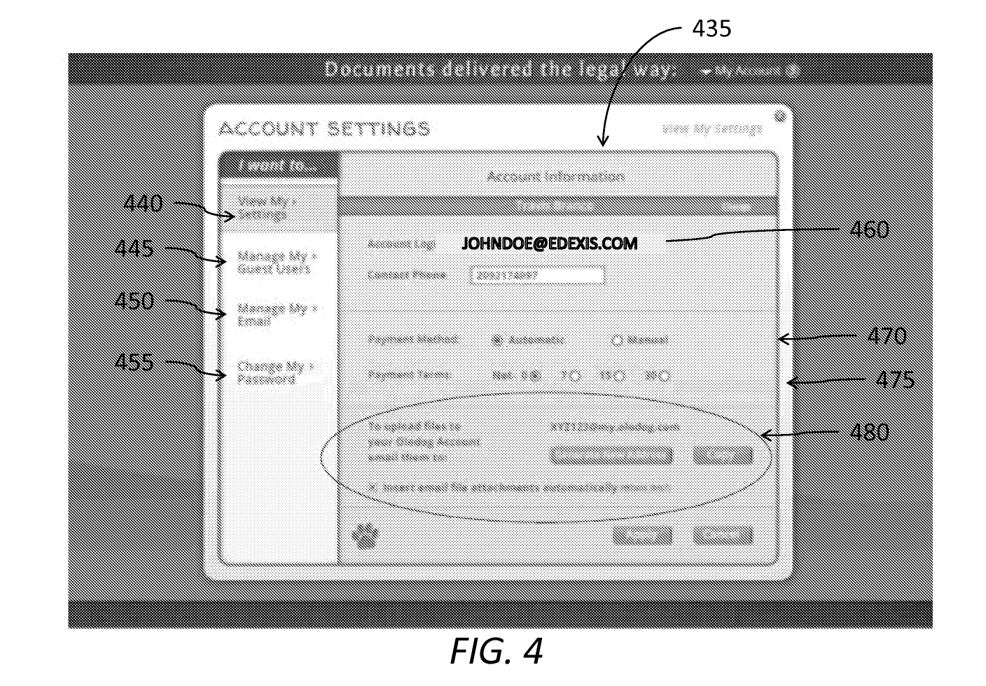

In order to determine whether the user has one or more account settings that permit the insertion of emails automatically, the document delivery system's server may check the account setting(s) for the user who was assigned the email address of xyz123@olodog.com. Referring now to FIG. 4, illustrated is a screenshot that shows a user's account settings in accordance with one embodiment of the present disclosure. Here, the user John Doe has chosen a setting that permits the insertion of emails automatically. This automatic email insertion setting is evidenced in the account information area 435 on the right portion of the screen. As shown at line 460, the account being viewed belongs to a user having a non-system email address as johndoe@edexis.com. The system may confirm the automatic email insertion setting via computer readable code. If the user had not had the automatic insertion feature activated, and/or the user had not used the “attach” keyword in the subject line of his email, the system may have stored the file on the server for the user to view and attach manually.

In FIG. 4, an account information area 435 is shown to the right, while a number of user-selectable buttons are shown to the left. Here, the user has selected the view my settings button 440, as indicated by the highlighted button 440 and the notation at the upper right of the screen that reads “view my settings”. Other possible buttons that could have been selected by the user include a manage my guest users button 445, a manage my email button 450, and a change my password button 455. As illustrated at line 470, the payment method may be automatic or manual. Here, the user has selected an automatic payment method. If a user has a credit card on file for the purpose of automatic debits, it may be indicated here. The payment terms may be shown at line 475. Here, the payment terms are 0, meaning the user has 0 days' grace period to pay. The user must pay on the date that the charges are incurred. Otherwise, as shown at line 475, the user would have the option of having his/her account debited or have payment otherwise made in the next 7, 15 or 30 days.

As shown in screenshot area 480, here is the information most pertinent to the setting for automatic email insertion. Here, as shown at the left portion of area 480, there is a notation “To upload files to your Olodog Account, email them to . . . ”. The email address indicated to the right of screenshot area 480 is xyz123@myolodog.com. The user has the option of allowing the system to randomly generate a new assigned email address by selecting the appropriate icon. The user also has the option of copying an email address by selecting the appropriate icon, and paste the email address into other programs. Importantly, the box is checked for “insert email file attachments automatically.” When this box is checked, the system knows the user has activated automatic email insertion. As shown at the bottom of the account information area 480, the user has the option to apply the current settings or to cancel so that the settings are not applied.

Behind the scenes, the server for the document delivery system has now stored the emailed files in its file system. The server may also link the received attachments to John Doe's account. The system may be configured so that it does not permit the automatic insertion of email attachments unless the user is in the process of creating a new mailing package. Here, John Doe has activated automatic email attachment insertion, and the server has determined that John Doe's user account is building a new mailing package. The system may also include settings that permit the user to select the option of being notified when attachments have been successfully uploaded. The system may notify John Doe via the user's registered non-system email account when the received attachment has been uploaded successfully. The server may now automatically insert the email attachment into the list of files in the mailing package. The server may also update the user's screen to display the new file(s) inserted into the mailing package.

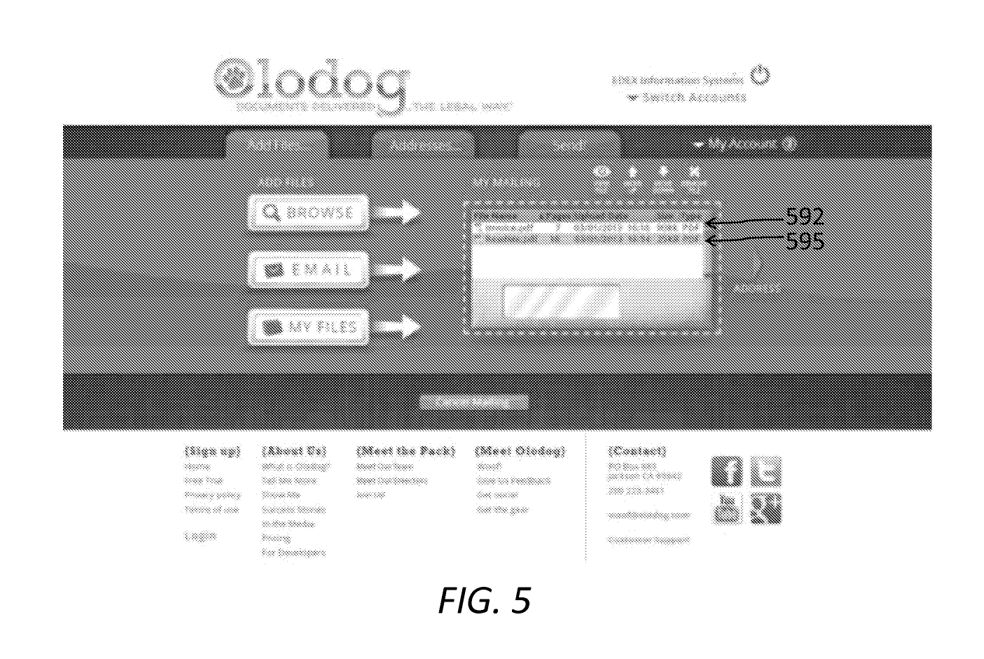

Referring now to FIG. 5, illustrated is a user screenshot that results after a user has successfully inserted an email attachment into a list of files in a mailing package in accordance with one embodiment of the disclosure. As shown in FIG. 5, not only is the original “invoice.pdf” file shown, but also shown at line 595 is the new file titled “readme”. As shown in the next column, the file is 18 pages. The upload date and time are Jan. 1, 2013 at 14:14. The file size (25 KB) and the file type (pdf) may also be shown. The user now sees the updated list of files and may continue the process of adding more files, if desired. The user may complete the addressing and submission of the mailing package in the same manner as other Olodog orders.

In lieu of, or in addition to, an email uploader, the document delivery system may incorporate the ability to upload via short message service (SMS) and multimedia messaging service (MMS). Upload may also be accomplished via a URL-based system, or a system that permits files to be transferred using file transfer protocol (“FTP”), an extension to file transfer protocol known as FTPS, secure file transfer protocol (SFTP), web-based file transfers using hypertext transfer protocol (HTTP) and other suitable file transfer protocols.

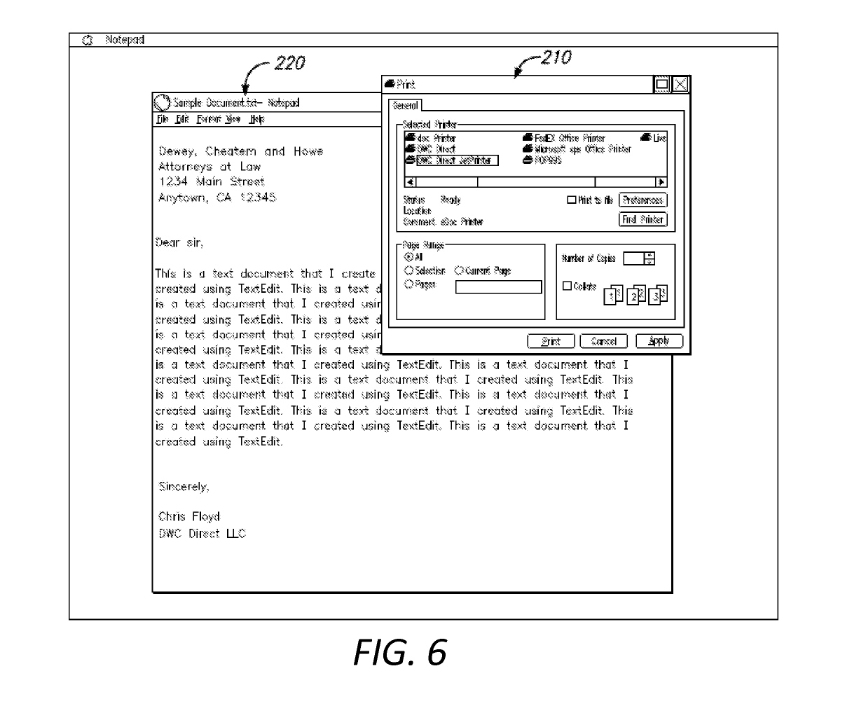

Referring now to FIG. 6, illustrated is the initial screen shown when a user submits a document into the document delivery system via web API (using the browser or “my files” mode) in accordance with one embodiment of the present disclosure. As shown, the screenshot includes an electronic document 220 that the sender wishes to have delivered. The user submits the document into the document delivery system when the user selects the “print” function and designates the specific printer for the document delivery system. Here, the print dialog box 210 shows that the user is making the selection for the document delivery system which is designated here as “DWC Direct JetPrinter.”

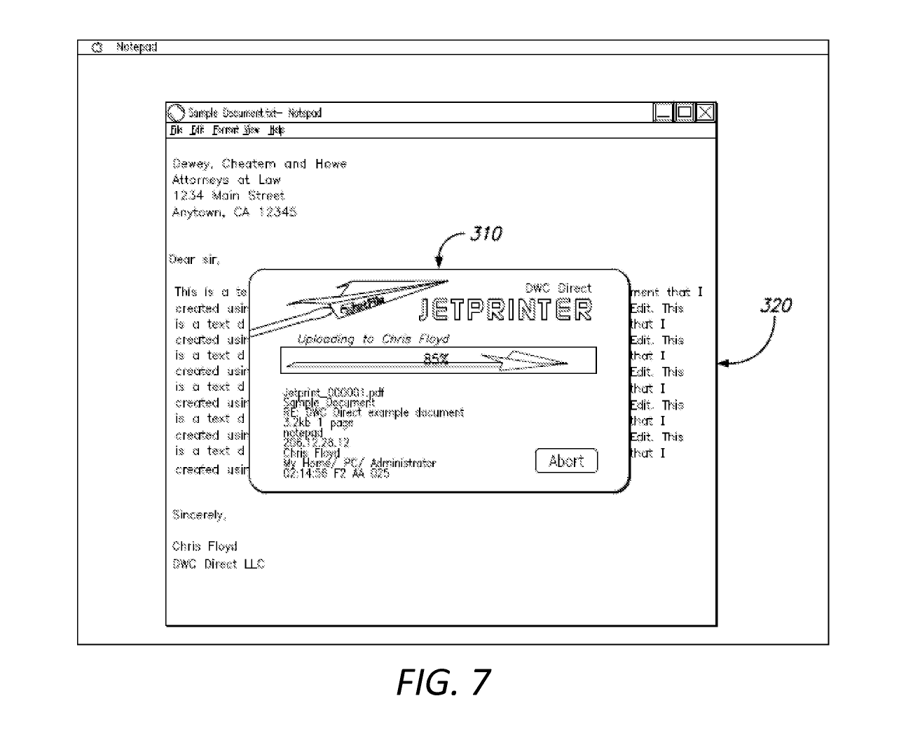

The user may now make sure the document or package (as represented by the electronic file) is uploaded into the system. Referring now to FIG. 7, illustrated is a screenshot showing an upload of a document into the document delivery system in accordance with one embodiment of the present disclosure. The electronic document 320 is shown with an upload dialog box 310. The upload dialog box indicates the progress of the upload. Here, the upload is eighty-five percent (85%) complete. This figure represents the percentage of the document's file size (in relation to its entire file size) that has uploaded into the system.

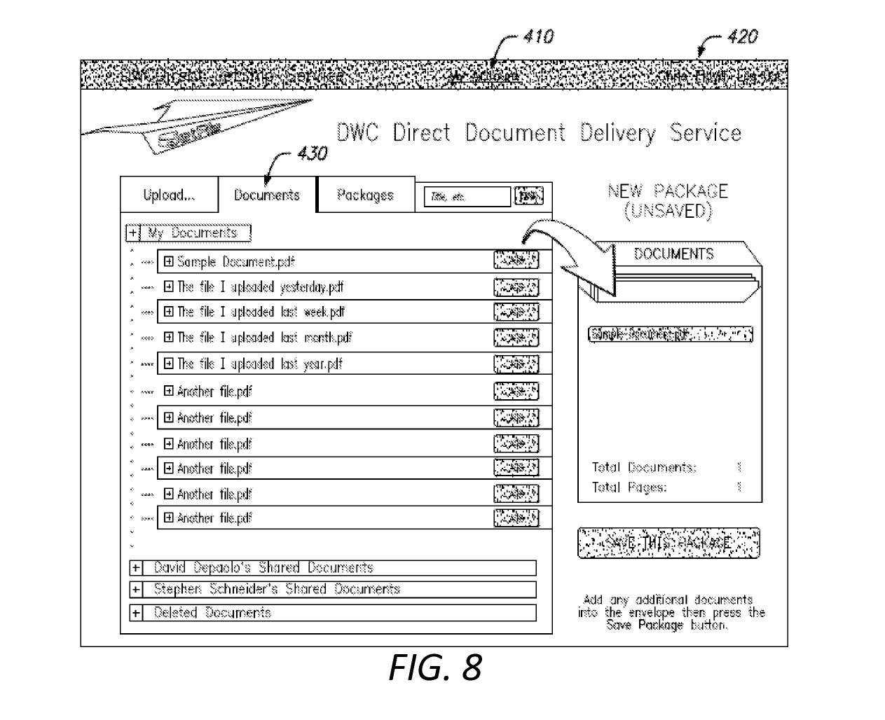

The user may manage and view uploads, documents and packages associated with the user's account by accessing the “My Account” section of the site. As part of this functionality, the user may enter documents into a package. Referring now to FIG. 8, illustrated is a screenshot that permits a user to enter documents into a package for the document delivery system in accordance with one embodiment of the present disclosure. At the uppermost part of the screen, the screenshot shows that the “My Account” section 410 of the site has been accessed by the user. The user's name can be seen at the user name section 420 of the screen. Here, the user is preparing to designate the document that was previously uploaded for delivery into a package. The user may add as many uploaded documents as the user would like into this package.

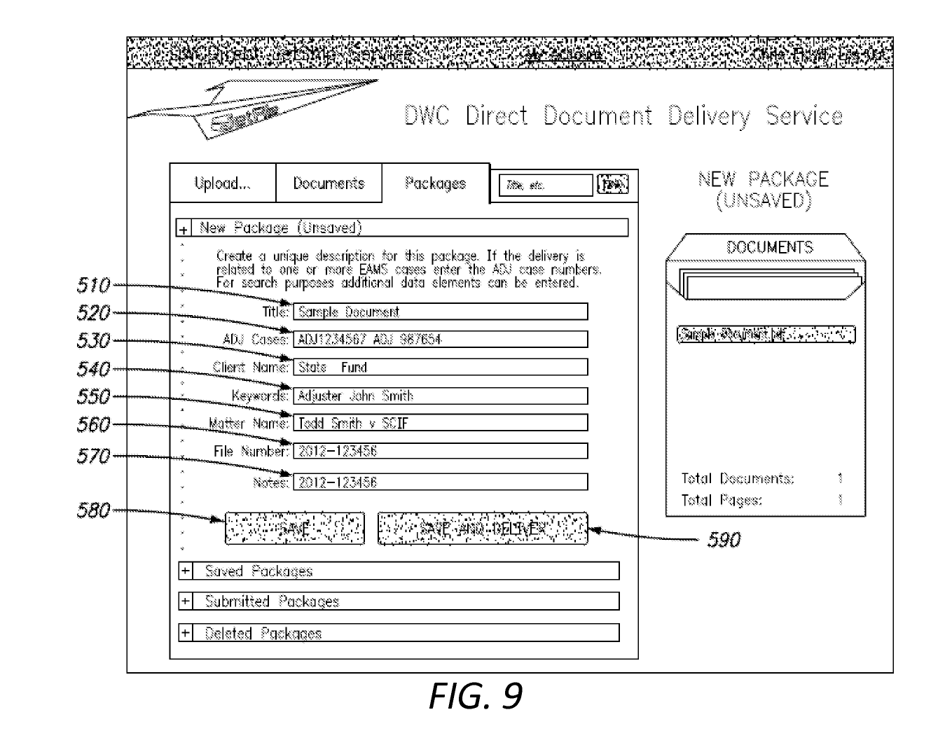

Referring now to FIG. 9, illustrated is a screenshot that permits a user to enter a unique description for a new package that is to be delivered with proof of service in accordance with one embodiment of the present disclosure. As shown, the user may enter a title for the package. Here, the title “Sample Package” has been entered at text box 510. The user may also enter a case number for the package as shown at text box 520 below the title field. A client name and keywords may also be associated with the package. Here, the client name is State Fund and the keywords are “Adjuster John Smith” as shown at text boxes 530 and 540. A matter name, file number and notes may be associated with the package. Here, the matter name is Todd Smith v. SCIF as shown at text box 550. The file number is 2012-123456 as shown at text box 560, and the notes are 2012-123456 as shown at text box 570. Then the package may be saved using the “save” button at 580. Alternatively, the package may be saved and delivered by selecting the appropriate button 590. From the “Packages” tab, the user may also view saved packages, submitted packages and deleted packages as shown by the expandable buttons located near the bottom of the screenshot.

It should be noted that the terms entered to describe the package are searchable. Thus, if a user wished to search for all files having Adjuster John Smith associated with them, the user would enter “Adjuster John Smith” in the field at the upper right portion of the screen.

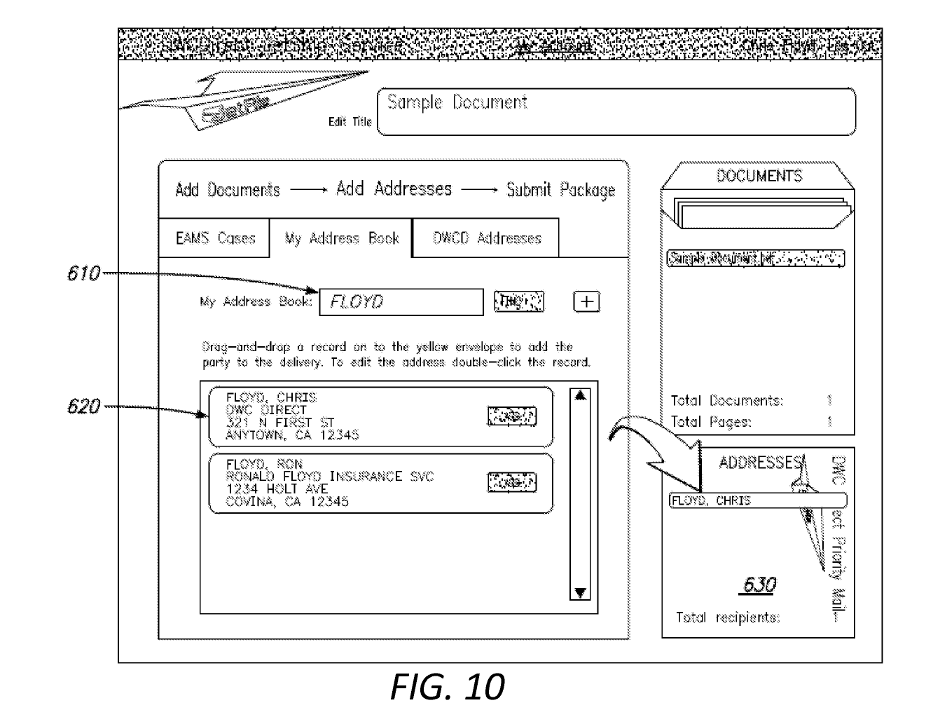

Referring now to FIG. 10, illustrated is a screenshot that permits a user to enter a recipient for the package and submit the package for delivery in accordance with one embodiment of the present disclosure. As shown near the top of the screen, the user may first add documents (performed in previous screenshot), then the user may add addresses. Finally, the sender submits the package. Here, the user is at the add address phase. The user selects the address(es) to which he/she would like the package delivered. Here, the addresses are separated by the user into three categories: (a) EAMS cases; (b) my address book; and (c) DWCD addresses. These categories represent the source for the address. The “My Address Book” source may represent a personal address book for the particular user. Here, the user has located the intended recipient by entering the search term Floyd in text box 610. The user then drags and drops the information for Chris Floyd from text box 620 into the envelope 630 at the right side of the screen.

Now, the user is preparing to submit the package. The system may be configured to validate, based on either a unique identification code for each received electronic document or a unique package identification number for a single multi-document package, that a multi-document package addressed to a physical endpoint includes all received electronic documents for a recipient at the physical endpoint.

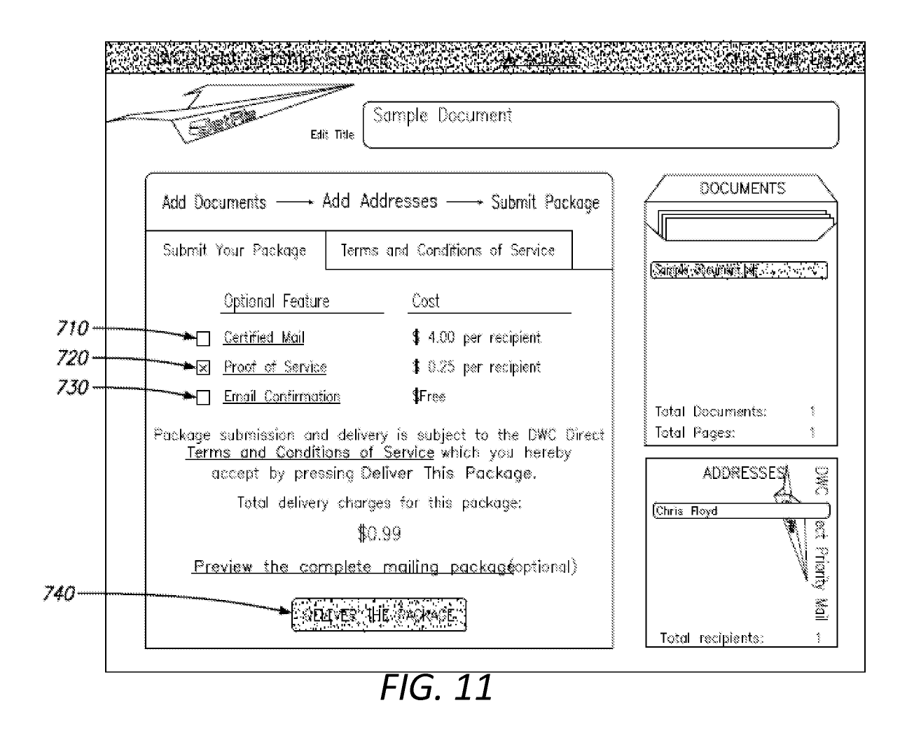

The user may also be permitted to select optional services for the package. Referring now to FIG. 11, illustrated is a screenshot that permits a user to select optional services for the package in accordance with one embodiment of the present disclosure. As shown in the screenshot, the user may choose the optional services of certified mail by selecting box 710, proof of service by selecting box 720, or email confirmation by selecting box 730. The cost for the particular service is shown to the right of the screenshot. As the user selects optional services, the total price for the selected services may be previewed. The user may also preview the complete mailing package, if desired. Finally, the user may select the “deliver package” icon at 740 in order to direct that the package be delivered. The terms and conditions of service may be viewed by selecting the appropriate tab near the top of the screen.

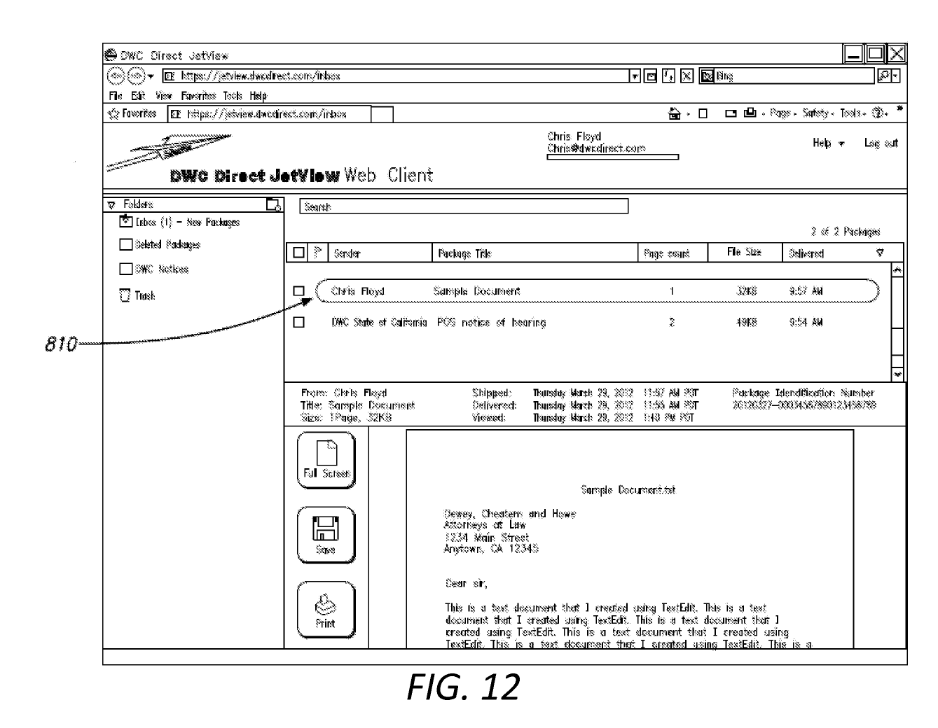

After the package has been delivered to a user who has agreed to accept electronic documents, the package may be viewed by the appropriate recipient when he/she logs into his/her account. Referring now to FIG. 12, illustrated is a screenshot at a recipient's computer after the recipient has opened the package subject to proof of service in accordance with one embodiment of the present disclosure. Here, the recipient has received a package from Chris Floyd as shown at line 810. The recipient can see that the title is “Sample Document” as also shown at line 810. The recipient can also see the page count, file size and time the package was delivered.

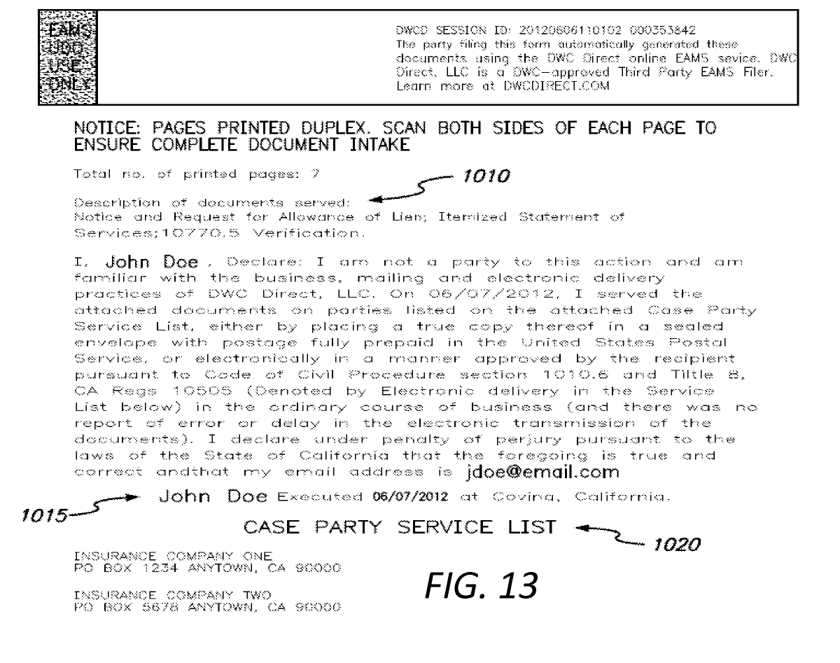

The sender had selected the proof of service option when submitting the package to the system. Therefore, the system may generate a proof of service after the system determines the delivery method as physical or electronic. The sender may receive a copy of this proof of service after it has been generated by the system. Referring now to FIG. 13, illustrated is an example of a proof of service generated by the system. Here, the proof of service is signed by John Doe. It shows the subject documents to be delivered are a Notice and Request for Allowance of Lien, an Itemized Statement of Services and a 10770.5 Verification as shown under line 1010 which reads “Description of Documents Served”. This proof of service shows the documents have been served on Insurance Company One and Insurance Company Two as shown at line 1020. The proof of service is signed by John Doe as shown at line 1015.

In addition to the proof of service, the sender may receive a receipt record showing that the document has been delivered to the recipient's account via the recipient's inbox, or that the document has been otherwise posted to the system for viewing by the intended recipient.

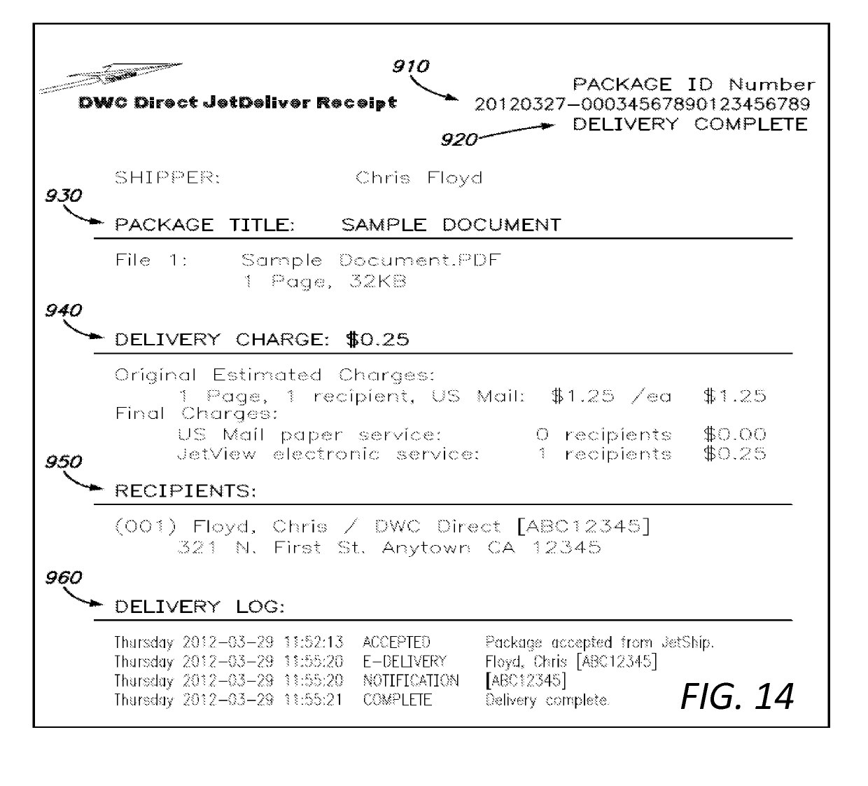

Referring now to FIG. 14, illustrated is a screenshot of a sender's receipt record for the package subject to proof of service in accordance with one embodiment of the present disclosure. This proof of service shows the unique package identification number at line 910 and that the package delivery is complete at line 920. The package title is also shown as “Sample Document” at line 930. The delivery charge is shown on the receipt at line 940. Also shown are the recipient at line and his address at line 950 and therebelow. Here, the recipient is Chris Floyd at DWC Direct whose address is 321 N. First St., Anytown, USA 12345. The delivery or audit log is shown at line 960 and below. It indicates the time that the package was accepted by the system for delivery. If the system is to carry out an electronic delivery the time stamps on the audit log showing electronic delivery and delivery completion may be very close to each other, e.g., within a second or two. In this example, delivery is carried out to a single electronic endpoint. However, if there were multiple endpoints in this example, and some were paper mail (not e-delivery), then the log may show different times for the e-delivery and the paper mail delivery times. The time differences could be in hours between the paper delivery end points and the e-delivery endpoints. In some cases, the time differences could be in days, since days might elapse between the time an electronic delivery occurs and a paper delivery occurs. For example, if a document was uploaded to the system on Friday, delivery to the paper endpoints might not begin until Monday, while the e-delivery endpoints would have received their documents on Friday.

The delivery log may show the date the system completed service of the subject document. In this example, the document in question was delivered electronically. Service may be considered complete when the document has been put into the recipient's electronic mailbox, or when the document has been otherwise posted to the system for viewing by the recipient. If the document is slated for physical delivery, service may be considered complete when the envelope has been deposited into a United States Postal Service mailbox or when the document was transferred or released to a carrier e.g., FEDERAL EXPRESS™ or a personal courier.

Using the document delivery system of the present disclosure, a sender/shipper may receive a legal proof of service on paper and electronic documents delivered to all recipients. Moreover, the aggregation of physical documents permits the sender/shipper to send the documents at an efficient price point. Where the documents are delivered electronically, the shipper may be able to reduce costs even further since no carrier or paper shipping costs would be applicable.

While the specification describes particular embodiments of the present invention, those of ordinary skill can devise variations of the present invention without departing from the inventive concept.

We claim:

1. A non-transitory computer-readable medium for uploading documents via email, and delivering the uploaded documents to electronic and/or physical endpoints, the computer readable medium embodying a set of instructions which, when executed by one or more computer processors, comprises:
a document receipt code segment configured to receive electronic documents for delivery to one or more physical and/or electronic endpoints, including each electronic document attached to an email that is addressed to an assigned system email address, wherein the document receipt code segment is also configured to receive recipient data with each said received electronic document, said recipient data indicating delivery to one or more physical and/or electronic endpoints;
an extraction and storage code segment configured to extract each received electronic document from each said email that is addressed to an assigned system email address, the code segment being further configured to store the extracted received electronic document,
wherein the extraction and storage code segment is also configured to link the extracted received electronic document to a user account associated with the assigned system email address to which the email containing the received electronic document was addressed, if the system email address to which the email containing the received electronic document is addressed matches an assigned system email address;
if a user account permits automatic email attachment inclusion, or if an attachment command is received for a received electronic document, an automatic email attachment inclusion code segment configured to verify that a sending user is building a package for mailing to the one or more physical and/or electronic endpoints, the automatic email attachment inclusion code segment being further configured to automatically store each extracted received electronic document into the user account associated with the assigned system email address to which the received electronic document was addressed;
a mail delivery code segment configured to determine whether a received electronic document is to be delivered to a recipient via physical or electronic endpoint based on the recipient data, wherein the mail delivery code segment is further configured to deliver the received electronic document to an electronic endpoint, if the determined endpoint is electronic;
an encryption code segment configured to provide encryption for each electronic document that is attached to each email addressed to an assigned system email address; and
a decryption code segment configured to decrypt each extracted received electronic document that has been encrypted.

2. The computer-readable medium of claim 1, further comprising:
an email address assignment code segment configured to assign a system email address to at least one system user.

3. The computer-readable medium of claim 1, wherein the document receipt code segment is further configured to receive a request for proof of service of each received electronic document to the one or more physical and/or electronic endpoints, and the system further comprises:
a proof of service code segment configured to provide proof of service of each served physical and/or electronic document if a proof of service request has been received.

4. The computer-readable medium of claim 1, further comprising:
a formatting code segment configured to format each received physical endpoint according to a formatting standard that permits aggregation of received electronic documents from multiple senders to a physical endpoint composed of known address components that substantially match address components for more than one received physical endpoint.

5. The computer-readable medium of claim 1, further comprising:
an aggregation code segment configured to facilitate the aggregation of physical documents into a single multi-document package from the multiple senders for delivery to the one or more endpoints, if the determined endpoint is physical, and wherein the aggregation code segment is further configured, based on unbundled delivery requirements associated with a particular endpoint of the one or more physical endpoints, not to aggregate physical documents for delivery in a package to the particular endpoint.

6. The computer-readable medium of claim 1, wherein the set of instructions further comprises:
a certified mail code segment configured to certify that an electronic document was opened by the recipient and/or that a physical document was delivered by the carrier to the physical endpoint.

7. The computer-readable medium of claim 1, wherein the set of instructions further comprises:
a change of delivery method code segment configured to receive a request to change the delivery method from electronic to physical, when the received electronic document is delivered to an electronic endpoint but remains unopened for a predetermined period of time, wherein in response to a request to change the delivery method from electronic to physical, the change of delivery method code segment is further configured to recall the unopened document from the electronic delivery endpoint and re-send the document by physical delivery.

8. The computer-readable medium of claim 1, further comprising:
a validation code segment configured to validate, based on either a unique identification code for each received electronic document, including each extracted received document, or a unique package identification number for a single multi-document package, that a multi-document package addressed to a physical endpoint includes all received electronic documents for a recipient at the physical endpoint.

9. A non-transitory computer-readable medium for uploading documents via email, and delivering the uploaded documents to electronic and/or physical endpoints, the computer readable medium embodying a set of instructions which, when executed by one or more computer processors, comprises:
a document receipt code segment configured to receive electronic documents for delivery to one or more physical and/or electronic endpoints, including each electronic document attached to an email that is addressed to an assigned system email address, wherein the document receipt code segment is also configured to receive recipient data with each said received electronic document, said recipient data indicating delivery to one or more physical and/or electronic endpoints;
an extraction and storage code segment configured to extract each received electronic document from each said email that is addressed to an assigned system email address, the code segment being further configured to store the extracted received electronic document,
wherein the extraction and storage code segment is also configured to link the extracted received electronic document to a user account associated with the assigned system email address to which the email containing the received electronic document was addressed if the system email address to which the received electronic document is addressed matches an assigned system email address;
if a user account permits automatic email attachment inclusion, or if an attachment command is received for a received electronic document, an automatic email attachment inclusion code segment configured to verify that a sending user is building a package for mailing to the one or more physical and/or electronic endpoints, the automatic email attachment inclusion code segment being further configured to automatically store each extracted received electronic document into the user account associated with the assigned system email address to which the received electronic document was addressed;
a mail delivery code segment configured to determine whether a received electronic document is to be delivered to a recipient via physical or electronic endpoint based on recipient data, wherein the mail delivery code segment is further configured to deliver the received electronic document to an electronic endpoint, if the determined endpoint is electronic;
a formatting code segment configured to format each received physical endpoint according to a formatting standard that permits aggregation of received electronic documents from multiple senders to a physical endpoint composed of known address components that substantially match address components for more than one received physical endpoint; and
an aggregation code segment configured to facilitate the aggregation of physical documents into a single multi-document package from the multiple senders for delivery to the one or more endpoints, if the determined endpoint is physical.

10. The computer-readable medium of claim 9, further comprising:
an encryption code segment configured to encrypt each electronic document that is attached to each email addressed to an assigned system email address.

11. The computer-readable medium of claim 9, further comprising:
a decryption code segment configured to decrypt each extracted received electronic document that has been encrypted.

12. The computer-readable medium of claim 9, further comprising:
a proof of service code segment configured to provide proof of service of each served physical and/or electronic document if a proof of service request has been received.

13. The computer-readable medium of claim 9, further comprising:
a validation code segment configured to validate, based on either a unique identification code for each received electronic document or a unique package identification number for the single multi-document package, that the multi-document package addressed to the physical endpoint includes all received electronic documents for a recipient at the physical endpoint.

14. A computer-based method for receiving electronic documents via email, and delivering the received electronic documents to physical and/or electronic endpoints, comprising the steps of:
providing, by a computer, encryption for each electronic document that is attached to each email addressed to an assigned system email address;
receiving, by the computer, a plurality of electronic documents, including electronic documents that are emailed to one or more assigned system email addresses;
receiving, by the computer, recipient data indicating delivery to one or more physical and/or electronic endpoints;
extracting and storing, by the computer, each of the received electronic documents from the email addressed to the assigned system email address;
decrypting, by the computer, each extracted received electronic document that has been encrypted;
linking, by the computer, the extracted received electronic documents to at least one user account associated with the one or more assigned system email addresses to which the email containing the received electronic document was addressed;
if a user account permits automatic email attachment inclusion, or if an attachment command is received for the extracted received electronic document, performing the following steps for each of the plurality of extracted received electronic documents:
verifying that a sending user is building a package for mailing to the one or more physical and/or electronic endpoints; and
automatically storing each extracted received electronic document into the user account associated with the assigned system email address to which the received electronic document was addressed;
determining, by the computer, whether a received electronic document is to be delivered to a recipient via physical or electronic endpoint based on recipient data; and
in response to the determining step, performing the following step for each of the plurality of received electronic documents:
if the determining step indicates delivery to an electronic endpoint, delivering, by the computer, the received electronic documents to electronic endpoints.

15. The method of claim 14, further comprising the step of:
validating, by the computer, based on either a unique identification code for each received electronic document or a unique package identification number for the single multi-document package, that the document or multi-document package addressed to the physical and/or electronic endpoint includes all received electronic documents for a recipient at the physical and/or electronic endpoint.

16. The method of claim 14, further comprising:
prior to the receiving step, assigning, by a computer, a system email address to at least one system user.

17. The method of claim 14, further comprising:
in response to the determining step, performing the following steps for each of the plurality of electronic documents:
if the determining step indicates delivery to a physical endpoint, formatting, by the computer, each received physical endpoint according to a formatting standard that permits aggregation of received electronic documents from multiple senders to a physical endpoint composed of known address components that substantially match address components for more than one received physical endpoint;
if the determining step indicates delivery to a physical endpoint, facilitating, by the computer, the aggregation of the physical documents into a single multi-document package for delivery to the one or more physical endpoints or, based on unbundled delivery requirements associated with a particular endpoint of the one or more endpoints, determining, by the computer, that aggregation will not occur for physical documents to the particular endpoint.

18. The method of claim 14, further comprising:
assigning, by the computer, a system email address to at least one system user.

19. The method of claim 14, wherein the receiving step further includes receiving a request for proof of service of each received electronic document to the one or more physical and/or electronic endpoints, and the method further comprises:
providing, by the computer, proof of service of each served physical and/or electronic document if a proof of service request has been received.

20. The method of claim 14, further comprising:
receiving, by the computer, a request for certified mail from the sender;
receiving, by the computer, certification that the recipient has opened the delivered electronic document and/or that the carrier has delivered the physical document to the recipient.

21. The method of claim 14, further comprising:
when the served electronic document is delivered to an electronic endpoint but remains unopened for a predetermined period of time, receiving, by the computer, a request to change the delivery endpoint from electronic to physical; and
recalling, by the computer, the unopened served electronic document from the electronic delivery endpoint and re-sending the served electronic document by physical delivery to a physical endpoint.
